(19) United States
(12) Patent Application Publication
(10) Pub. No.: US 2025/0229452 A1
(43) Pub. Date: Jul. 17, 2025

(54) METHOD FOR PRODUCING A BENT IN A PLANK AND PLANK PRODUCED BY THE METHOD

(71) Applicants: Aleftin Martens, Verl (DE); Markus Schalkamp, Henderson, NC (US)

(72) Inventors: Aleftin Martens, Verl (DE); Markus Schalkamp, Henderson, NC (US)

(21) Appl. No.: 18/414,845

(22) Filed: Jan. 17, 2024

(30) Foreign Application Priority Data
Jan. 17, 2024 (DE) 10 2024 101 226.9

(51) Int. Cl. B27H 1/00

(52) U.S. Cl. CPC B27H 1/00

(57) ABSTRACT

The provided method offers a way to manufacture a curved edge (1) on a straight flat plank (2), resulting in planks with curved edges that can be economically produced in a short amount of time.

### CROSS-REFERENCE TO RELATED APPLICATIONS

This application claims priority to German Patent Application No. DE 10 2024 101 226.9, filed on Jan. 17, 2024, the entire contents of which is incorporated by reference herein.

### BACKGROUND

The invention relates to a procedure for producing a curved edge on a straight flat plank, as well as a plank according to the terms of claims 1 through 12.

### SUMMARY

A method and device for manufacturing furniture or housing parts with curved corners are known (DE 31 31 085 A1). In this method, MDF boards in the future corner areas are mechanically provided with indentations on the bending side, which are then filled with glue and, after softening the MDF board with the moist glue, bent into a round corner around a counter-holder applied to the bending side.

This method is very time-consuming, requires a complex device, and allows only individual MDF boards to be processed in one clamping, with individual process steps, especially softening the bending area, taking disproportionately long periods. Thus, the entire known process is highly complicated and uneconomical.

The objective of the invention is to provide a procedure for producing a curved edge on a straight flat plank or board that is significantly more efficiently executable and can economically produce a variety of planks with curved edges in the shortest time.

The solution to this problem arises in connection with the terms of claims 1 through 12 together with their distinguishing parts. The inventive procedure for producing a curved edge on a straight flat plank, especially a floor panel, proceeds as follows: in a first step, the plank is lengthwise provided on its underside in a lateral shaping area with a multitude of closely spaced and parallel uninterrupted longitudinal grooves; in a second step, the longitudinal grooves and the surfaces in between are provided with adhesive; in a third step, a foil sheet is applied as a counteracting material from the beginning of the plank, spanning over all the longitudinal grooves of the shaping area; in a fourth step, the plank is heated; in a fifth step, the shaping area of the plank is formed towards the longitudinal grooves; and in a sixth step, the formed shape is allowed to cool or actively cooled.

This procedure allows the continuous passage of multiple straight flat planks one after the other through an appropriate device. Thus, it eliminates the need to wait for the softening of the shaping area due to the glue; instead, the shaping can begin immediately once the counteracting material is applied to the longitudinal grooves with adhesive and the plank is heated. The device can be extended as desired behind the deformation area to allow sufficient time for the finished curved plank to cool. In some cases, active cooling may be applied, but it can also be easily provided if necessary.

Further advantageous embodiments of the subject matter of the invention result from and in combination with the subsequent subclaims.

According to a particularly preferred embodiment of the invention, the method, for a thick plank, includes a zeroth preliminary step in which the shaping area is milled thinner from an initial thickness of the plank to a minimum processing thickness. This makes it easier to deform less elastic material of a straight flat plank.

Furthermore, an eighth step is advantageous, which consists of a resting process, during which, in the presence of humidity, a chemical curing of the finished plank takes place in a period of twelve hours up to several days. This ensures that the finished plank cannot return to its original shape, resulting in a very stable curved edge that is equally resilient as the surface of the plank itself.

Preferably, a PUR adhesive is used, which can be easily applied to the shaping area into the longitudinal grooves and on the surfaces in between using a spray nozzle, preferably when the plank is upside down to completely avoid dripping of the adhesive.

The shaping area on the underside of the flat plank can also be advantageously divided into several zones. This allows not only the production of purely partially cylindrical curved edges but also cross-sections with polygenic edges or edges with different radius ranges. For this purpose, a plank is provided with regularly or section-wise regularly arranged longitudinal grooves and/or different widths and/or depths of longitudinal grooves so that different edge shapes result in the deformed area.

According to an advantageous process section, a melamine resin-impregnated paper web or a plastic web is used as the counteracting material foil, which is pressed onto the shaping area from rolls in multiple consecutive areas by the folding device used for the process, ensuring that the viscous adhesive cannot escape laterally from the adhesive joints.

In the fifth step of the deformation of this continuously moving plank, the deformation is carried out continuously and increasingly over a multitude of feed rollers set closer together over the transport length, where the transport length exceeds more than twice the length of a plank. This ensures that the deformation occurs gradually and uniformly, preventing sudden deformation. Additionally, for shaping the edge of the plank, a forming section with heating, forming, and cooling can be used, and multiple folding machines can be connected in series.

The procedure is advantageously carried out with planks made of solid plastic or composite material or laminates consisting of a base and a decorative and robust top layer. Vinyl is preferably used as the plastic, and the procedure is continuously carried out in sequence from the second to the sixth step on a corresponding shaping device.

With the procedure, a plank, especially a floor panel, is provided with a transformed curved front edge. The plank is lengthwise provided on its underside with a multitude of closely spaced and parallel continuous longitudinal grooves, and adhesive is applied to the longitudinal grooves and the surfaces in between, with a foil sheet applied over all the longitudinal grooves, and the plank is deformed in a heated state in the shaping area towards the longitudinal grooves, with the formed shape allowed to cool or actively cooled. For easy processing, a thick plank can be milled thinner in a preliminary step in the shaping area from an initial thickness to a minimum processing thickness, allowing various thickness planks to be suitable for the procedure.

After actively carrying out the procedure for producing the plank, the formed shape is stabilized in a subsequent resting process, during which the adhesive chemically cures in the presence of humidity. The adhesive preferably consists of PUR adhesive. The plank itself is preferably equipped with a partially cylindrical or polygonal curved edge in cross-section, and the counteracting material foil, for example, is made of melamine resin-impregnated paper or a plastic sheet.

The plank itself, according to the invention, is made of solid plastic, such as vinyl, or a composite material or laminate consisting of a base and a decorative and robust top layer. The longitudinal grooves introduced into the plank are advantageously V- or U-shaped, but can also have other cross-sections that contribute to a cross-section deviating from a partially cylindrical shape if desired. The longitudinal grooves can also extend different depths beneath the surface of the plank, allowing the appearance of the result to vary. Thus, the plank can be manufactured in a variety of conceivable variants.

Particularly advantageous is the plank produced by the inventive method with its transformed and curved edge, which can be used as a stair step with the curved edge as the step leading edge.

The opposite back edge of the plank to the curved edge can, as usual with such planks, be provided with a connecting profile, so that additional flat planks of a floor can be easily connected to it, for example, in click panels by simply snapping together, without the planks needing to be glued to each other.

Below is the procedure for producing a curved edge of a straight flat plank illustrated in drawings. The drawings show:

### BRIEF DESCRIPTION OF THE DRAWINGS

FIG. 1: A plank after a preliminary step,

FIG. 2: A plank after the introduction of longitudinal grooves,

FIG. 3: A plank after filling the longitudinal grooves and adjacent surfaces with adhesive,

FIG. 4: A third step with a counteracting material applied on the adhesive, and

FIG. 5: A finished plank with a curved edge as a stair step.

### DETAILED DESCRIPTION

The stair step with a curved edge 1, produced from the plank 2, has a flat surface 9, possibly with a printed and/or molded wood grain or similar, as well as a smooth underside 4. On the side opposite the curved edge 1, as shown in FIG. 5, there is a connecting profile 10 for connecting additional planks 2.

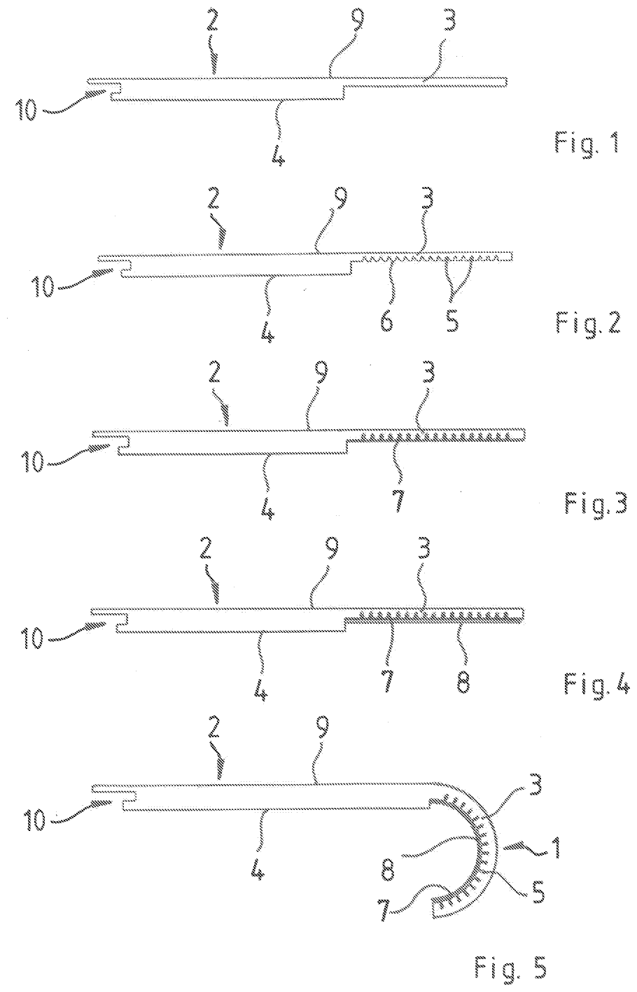

The curved edge 1 is made from a thinly milled shaping area 3, which is milled thinner from an initial thickness of the plank to a minimum processing dimension, as shown in FIG. 1.

This shaping area 3 is provided with a plurality of closely spaced and mutually parallel continuous longitudinal grooves 5, as illustrated in FIG. 2. These longitudinal grooves 5 are equidistant and equally deep, as shown in FIG. 2, but they can also be spaced differently from each other and executed with varying depths and different cross-sections. Thus, the curved edge 1 can have cross-sectional forms deviating from a circular cylindrical shape.

On the adhesive 7 applied through a nozzle, a film 8 is applied as a counteracting material, which extends continuously from the beginning of the plank 2 from the roll over all longitudinal grooves 5 of the shaping area 3. This ensures that the adhesive 7 does not contaminate the folding devices used, allowing the process to be carried out without interruption. A variety of planks 2 with curved edges 1 can be produced consecutively in an uninterrupted continuous process.

1. A method for the production of a curved edge (1) on a straight flat plank (2), especially a floor panel, comprising:
a plank (2) is, in a first step, lengthwise provided on its underside (4) in a lateral shaping area (3) with a plurality of closely spaced and parallel continuous longitudinal grooves (5), in a second step, the longitudinal grooves (5) (and the surfaces in between) are provided with an adhesive (7), in a third step, a foil sheet (8) is applied as a counteracting material from the beginning of the plank (2) over all the longitudinal grooves(S) of the shaping area (3), in a fourth step, the plank (2) is heated, in a fifth step, the shaping area (3) of the plank (2) is formed towards the longitudinal grooves (5), and in a seventh step, the formed shape is allowed to cool or actively cooled.

2. The method of claim 1, further comprising, in a preliminary step 0, the shaping area (3) is milled thinner from an initial thickness of the plank (2) to a minimum processing dimension.

3. The method of claim 1, further comprising, in an eighth step, a chemical curing process of the finished plank (2) is allowed to take place in a resting process for 12 hours to several days.

4. The method of claim 1, further comprising a polyurethane adhesive (7) is-being used as the adhesive.

5. The method of claim 1, wherein the plank (2) is provided with a partially cylindrical or polygonal cross-section edge (1).

6. The method of claim 1, further comprising a melamine resin-impregnated paper or a plastic sheet is used as the foil sheet (8) of the counteracting material.

7. The method of claim 1, wherein the shaping in the sixth step is continuously increasing with a continuously moving plank (2) and occurs over a plurality of feed rollers set closer together over the transport length, where the transport length is more than twice the length of a plank (2).

8. The method of claim 1, wherein for shaping the edge (1) of the plank (2), it passes through a forming section with heating, forming, and cooling.

9. The method of claim 1, wherein the plank (2) is made of solid plastic or composite material or of a laminate of a base and a decorative and robust top layer.

10. The method of claim 9, wherein vinyl is used as the plastic.

11. The method of claim 1, wherein the steps 2 to 7 are carried out continuously in succession on a shaping device.

12. A plank (2), especially floor panel that is provided with a formed curved edge (1) and produced by the method of claim 1 claims.

13. The plank (2) of claim 12, wherein, lengthwise on its underside (4) in a lateral shaping area (3), the plank is provided with a plurality of closely spaced and parallel continuous longitudinal grooves (5) into which and onto the surfaces in between an adhesive (7) and above it a foil sheet are applied over all the longitudinal grooves(S), the plank (2) is shaped in a heated state in a shaping area (3) towards the longitudinal grooves (5), and the formed shape is allowed to cool or actively cooled.

14. The plank (2) of claim 13, wherein, in a preliminary work step, the shaping area (3) is milled thinner from an initial thickness of the plank (2) to a minimum processing dimension.

15. The plank (2) of claim 13, wherein the plank is chemically cured in a final resting process.

16. The plank (2) of claim 13, wherein the adhesive (7) is a polyurethane adhesive.

17. The plank (2) of claim 13, wherein the plank (2) has a partially cylindrical or polytonally curved edge (1).

18. The plank (2) of claim 13, wherein the foil sheet (8) of the counteracting material is a melamine resin-impregnated paper or a plastic sheet.

19. The plank (2) of claim 13, wherein the plank is made of solid plastic or composite material or a laminate of a base and a decorative and robust top layer.

20. The plank (2) of claim 19, wherein the plastic is vinyl.

21. The plank (2) of claim 13, wherein the longitudinal grooves (5) are V- or U-shaped.

22. The plank (2) of claim 13, wherein the longitudinal grooves (5) extend until shortly before the surface (6) of the plank (2).

23. The plank (2) of claim 13, characterized in that wherein the side surfaces of the longitudinal grooves (5) in the formed state of the shaping area (3) abut each other or are glued together while maintaining an adhesive gap.

24. The plank (2) of claim 13, wherein the plank is designed as a stair step, and the formed curved edge (1) is the front edge of the step.

25. The plank (2) of claim 24, wherein the edge opposite to the curved edge (1) of the plank (2) is equipped with a connecting profile (10) for connecting further flat planks (2).
